(19) United States
(12) Patent Application Publication
(10) Pub. No.: US 2005/0177352 A1
(43) Pub. Date: Aug. 11, 2005

(54) Defect identification signal analysis method

(75) Inventor: David Gravel, Canton, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Motor Company, Dearborn, MI (US)

(21) Appl. No.: 10/772,876

(22) Filed: Feb. 5, 2004

(51) Int. Cl. G06F 17/10

(52) U.S. Cl. 703/2

(57) ABSTRACT

The present invention provides a method of identifying a defect in a part by forming a dot product between a vector related to a part with a known defect and a vector related to a part with an unknown defect. The magnitude of the dot product has been found to increase as the likelihood that unknown defect is the know defect increases. The components of each of these vectors determined from a quantifiable physical property capable of discriminating between parts with and without defects. The most useful quantifiable physical property for the method of the invention is the magnitudes of vibrations in an operating part. Frequency spectrum generated with this property are easily analyzed and defects identified. The present invention provides another method of identifying defects that is readily applicable to time domain spectra also uses dot product but shifts the vector to maximize the dot product.

### BACKGROUND OF THE INVENTION

1. Field of the Invention

The present invention relates to a method of identifying the type of defects in a part by analyzing vibrational frequency spectra or rotational order spectra.

2. Background Art

The identification of defects is an important aspect in the manufacturing of mechanical parts and in particular to automobile parts. Not only is it important to identify the presence of a defective part in the manufacturing facility before the part is shipped, determination of the root cause of a defect always for an increase in productivity and concurrent cost savings. Identification and correction of such defects within a vehicle powertrain is particularly important because of the relative high cost of such components.

Noise, Vibration, and Harshness (“NVH”) evaluation is often made at the end of the manufacturing lines on engine and transmission test stands. Data is gathered in such an evaluation using a transducer that converts vibrational energy into an electrical signal. Typically, these transducers which are called accelerometers are placed in contact with the part. Alternatively, a laser vibrometer that measures acceleration optically may be used. The output of these transducers is usually an electrical signal that represents the time domain signal (often called signatures) of the vibrational amplitude of the part under test. Time domain signatures can be converted to frequency spectra using a Fast Fourier Transform (“FFT”). The frequency spectra may be further processed on the frequency axis to represent orders, which are determined with respect to either the input or output rotational frequency for engines and transmissions.

Test spectra processed in this manner are often able to indicate NVH problems by the magnitude of vibrational energy at particular orders. However, root cause determination from the patterns in such spectra is hard to determine, especially for repair personnel on the factory floor. Accordingly, effective repair and process improvement is often difficult to implement.

Accordingly, there exists a need for an improved method of identifying defects in an engine or transmission components that always for the root cause of a given defective part.

### SUMMARY OF THE INVENTION

The present invention overcomes the problems of the prior art by providing in one embodiment a method of identifying a defect in a part by forming a dot product between a vector related to a part with a known defect and a vector related to a part with an unknown defect. The magnitude of the dot product has been found to increase as the likelihood that unknown defect is the known defect increases. The components of each of these vectors determined from a quantifiable physical property capable of discriminating between parts with and without defects. The most useful property for the method of the present invention is vibrational magnitudes present in running parts. If vibratonal magnitudes are used, the vector components will be the vibrational magnitude at a series of wavelengths. If an rotational order spectrum is used, the vector components are the vibrational magnitudes at a series of orders. Optionally a vector derived from a part without any defects may be subtracted from both the vector related to a part with a known defect and the vector related to a part with an unknown defect prior to forming the dot product. Moreover, vectors created in this manner may optionally be normalized prior to forming the dot product.

In another embodiment of the present invention, the method of identifying a defect in a part set forth above is repeated for a series of part with known defects. In this embodiment a library of defect vectors is created. The dot product between each defect vector in the library and the vector related to a part with an unknown defect is formed. The dot product with the greatest magnitude will provide the defect that is most likely present in the part.

### BRIEF DESCRIPTION OF THE DRAWINGS

FIG. 1 is a representation of the averaging process for a part without a defect and a part with a known defect;

FIG. 2 is a rotational order spectrum of a part without a defect;

FIG. 3 is a rotational order spectrum for a part with the known defect pump pollution;

FIG. 4 is the difference spectrum calculated from the difference between the rotational spectra in FIGS. 2 and 3 which corresponds to the difference vector C; and

FIG. 5 provides time domain plots that have been analyzed using the method of the invention to identify a part with a missing ring in a piston.

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventors.

In an embodiment of the present invention, a method of determining whether a defect is present in a part is provided. The method of the invention comprises:
a) identifying a numerically quantifiable physical property that provides good part array Aᵢ of n numerical values given by equation 1 that characterize a first reference part without a defect and defect array Bᵢ of n values as provided by equation 2 that characterize a second reference part with a known defect:
   Aᵢε(A₁, A₂, . . . Aₙ) 1;
   Bᵢε(B₁, B₂, . . . Bₙ) 2;
   wherein,
n is an integer, and
array Aᵢ and array Bᵢ are ordered by an independent parameter pᵢ that is associated with the values in array Aᵢ and array Bᵢ through the functional relationship Aᵢ=fₐ(pᵢ) and Bᵢ=f_{b}(pᵢ)
b) creating good part vector A of n dimensions as provided by equation 3 whose components are the n numerical values in good part array Aᵢ:
   A=<A₁, A₂, . . . Aₙ> 3;
   (Vectors herein will be written in bold.)
c) creating defect vector B of n dimensions as provided by equation 4 whose components are the n values in defect array Bᵢ:
   B=<B₁, B₂, . . . Bₙ> 4;
d) identifying vector R by selecting a vector from the group consisting of vector B, vector C, vector D, and vector E;
   wherein,
vector C is created by taking the difference between good part vector A and defect vector B as provided in equation 5:
   C=A−B 5; and
vector D is formed by:
1) creating difference vector C of n dimensions as provided by equation 5 which is the difference between good part vector A and defect vector B:
   C=A−B 5;
2) identifying m components of vector C as provided by equation 6 having the largest magnitudes:
   C′ᵢε(C′₁, C′₂, . . . C′ₘ) 6;
3) creating vector D of m dimensions as provided by equation 7 whose components are the n values in array Cᵢ

$$D = 〈 {C}_{1}^{′} , {C}_{2}^{′} , … {C}_{m}^{′} 〉 \\ = 〈 {D}_{1} , {D}_{2} , … {D}_{m} 〉 ; \qquad 7$$

and
vector E is formed by:
1) creating difference vector C of n dimensions as provided by equation 5 which is the difference between good part vector A and defect vector B:
   C=A−B 5;
2) identifying m components of vector C as provided by equation 6 having the largest magnitudes:
   C′ᵢε(C′₁, C′₂, . . . C′ₘ) 6;
3) creating vector D of m dimensions as provided by equation 7 whose components are the n values in array C′ᵢ

$$D = 〈 {C}_{1}^{′} , {C}_{2}^{′} , … {C}_{m}^{′} 〉 \\ = 〈 {D}_{1} , {D}_{2} , … {D}_{m} 〉 ; \qquad 7$$

and
4) normalizing vector D to form vector E as provided in equation 9:
   E=D/|D| 8;
e) determining array Fᵢ of n numerical values as provided by equation 9 that characterize a test part that may have an unknown defect using the numerically quantifiable physical property:
   Fᵢε(F₁, F₂, . . . Fₙ) 9;
f) creating vector F of n dimensions as provided by equation 10 whose components are the n values in array Fᵢ:
   F=<F₁, F₂, . . . Fₙ> 10;
g) identifying vector S by selecting a vector selected from the group consisting of vector F, vector G, vector H, and vector I,
   wherein,
vector G is formed by taking the difference between vector A and vector F as provided in equation 11;
   G=A−F 11; and
vector H is formed by:
1) creating vector G as provided by equation 11 which is the difference between vector A and vector F:
   G=A−F 11;
2) identifying m components of vector G as provided by equation 12 which correspond to the same values for pᵢ as the m components selected in step d for vector F:
   G′ᵢε(G′₁, G′₂, . . . G′ₘ) 12;
3) creating vector H as provided in equation 13 of dimension m having as components only the m components of step 2:

$$H = 〈 {G}_{1}^{′} , {G}_{2}^{′} , … {G}_{m}^{′} 〉 \\ = 〈 {H}_{1} , {H}_{2} , … {H}_{m} 〉 ; \qquad 13$$
4) normalizing vector H to create vector I as provided in equation 14:
   I=H/|H| 14; and
vector I is formed by:
1) creating vector G as provided by equation 11 which is the difference between vector A and vector F:
   G=A−F 11;
2) identifying m components of vector G as provided by equation 12 which correspond to the same values for pᵢ as the m components selected in step d for vector F:
   G′ᵢε(G′₁, G′₂, . . . G′ₘ) 12;
3) creating vector H as provided in equation 13 of dimension m having as components only the m components of step 2:

$$H = 〈 {G}_{1}^{′} , {G}_{2}^{′} , … {G}_{m}^{′} 〉 \\ = 〈 {H}_{1} , {H}_{2} , … {H}_{m} 〉 ; \qquad 13$$
4) normalizing vector H to create vector I as provided in equation 14:
   I=H/|H| 14; and
h) forming dot product DP as provided in equation 15:
   DP=R*S 15;
   wherein the dot product provides a number related to the probability that the test part that may have an unknown defect has the known defect in the second reference part with the proviso that when
vector B is selected in step d vector F is selected in step g,
vector C is selected in step d vector G is selected in step g,
vector D is selected in step d vector H is selected in step g, and
vector E is selected in step d vector I is selected in step g.

The various variations of the present invention as described by the proviso are best appreciated by explicitly providing the step for a few. When vector E is selected in step d vector I is selected in step g. The method of this variation comprises:
a) identifying a numerically quantifiable physical property that provides good part array Aᵢ of n numerical values given by equation 1 that characterize a first reference part without a defect and defect array Bᵢ of n values as provided by equation 2 that characterize a second reference part with a known defect:
   Aᵢε(A₁, A₂, . . . Aₙ) 1;
   Bᵢε(B₁, B₂, . . . Bₙ) 2;
   wherein,
n is an integer, and
array Aᵢ and array Bᵢ are ordered by an independent parameter pᵢ that is associated with the values in array Aᵢ and array Bᵢ through the functional relationship Aᵢ=fₐ(pᵢ) and Bᵢ=f_{b}(pᵢ);
b) creating good part vector A of n dimensions as provided by equation 3 whose components are the n numerical values in good part array Aᵢ:
   A=<A₁, A₂, . . . Aₙ> 3;
c) creating defect vector B of n dimensions as provided by equation 4 whose components are the n values in defect array Bᵢ:
   B=<B₁, B₂, . . . Bₙ> 4;
d) forming vector E by the method comprising;
1) creating difference vector C of n dimensions as provided by equation 5 which is the difference between good part vector A and defect vector B:
   C=A−B 5;
2) identifying m components of vector C as provided by equation 6 having the largest magnitudes:
   C′ᵢε(C′₁, C′₂, . . . C′ₘ) 6;
3) creating vector D of m dimensions as provided by equation 7 whose components are the n values in array C′ᵢ

$$D = 〈 {C}_{1}^{′} , {C}_{2}^{′} , … {C}_{m}^{′} 〉 \\ = 〈 {D}_{1} , {D}_{2} , … {D}_{m} 〉 ; \qquad 7$$

and
4) normalizing vector D to form vector E as provided in equation 9:
   E=D/|D| 8;
e) determining array Fᵢ of n numerical values as provided by equation 9 that characterize a test part that may have an unknown defect using the numerically quantifiable physical property:
   Fᵢε(F₁, F₂, . . . Fₙ) 9;
f) creating vector F of n dimensions as provided by equation 10 whose components are the n values in array Fᵢ:
   F=<F₁, F₂, . . . Fₙ> 10;
g) forming vector I by the method comprising:
1) creating vector G as provided by equation 11 which is the difference between vector A and vector F:
   G=A−F 11;
2) identifying m components of vector G as provided by equation 12 which correspond to the same values for pᵢ as the m components selected in step d for vector F:
   G′ᵢε(G′ᵢ, G′₂, . . . G′ₘ) 12;
3) creating vector H as provided in equation 13 of dimension m having as components only the m components of step 2:

$$H = 〈 {G}_{1}^{′} , {G}_{2}^{′} , … {G}_{m}^{′} 〉 \\ = 〈 {H}_{1} , {H}_{2} , … {H}_{m} 〉 ; \qquad 13$$
4) normalizing vector H to create vector I as provided in equation 14:
   I=H/|H| 14; and
h) forming dot product DP as provided in equation 15′:
   DP=E·I 15′;
   wherein the dot product provides a number related to the probability that the test part that may have an unknown defect has the known defect in the second reference part.

The method of the variation corresponding to when vector B is selected in step d vector F is selected in step g. This method will include only steps a, b, c, e, f, and h. The method of this variation comprises:
a) identifying a numerically quantifiable physical property that provides good part array Aᵢ of n numerical values given by equation 1 that characterize a first reference part without a defect and defect array Bᵢ of n values as provided by equation 2 that characterize a second reference part with a known defect:
   Aᵢε(A₁, A₂, . . . Aₙ) 1;
   Bᵢε(B₁, B₂, . . . Bₙ) 2;
   wherein,
n is an integer, and
array Aᵢ and array Bᵢ are ordered by an independent parameter pᵢ that is associated with the values in array Aᵢ and array Bᵢ through the functional relationship Aᵢ=fₐ(pᵢ) and Bᵢ=f_{b}(pᵢ);
b) creating good part vector A of n dimensions as provided by equation 3 whose components are the n numerical values in good part array Aᵢ:
   A=<A₁, A₂, . . . Aₙ> 3;
c) creating defect vector B of n dimensions as provided by equation 4 whose components are the n values in defect array Bᵢ:
   B=<B₁, B₂, . . . Bₙ> 4;
e) determining array Fᵢ of n numerical values as provided by equation 9 that characterize a test part that may have an unknown defect using the numerically quantifiable physical property:
   Fᵢε(F₁, F₂, . . . Fₙ) 9;
f) creating vector F of n dimensions as provided by equation 10 whose components are the n values in array Fᵢ:
   F<F₁, F₂, . . . Fₙ> 10;
h) forming dot product DP as provided in equation 15:
   DP=R*S 15;
   wherein the dot product provides a number related to the probability that the test part that may have an unknown defect has the known defect in the second reference part.

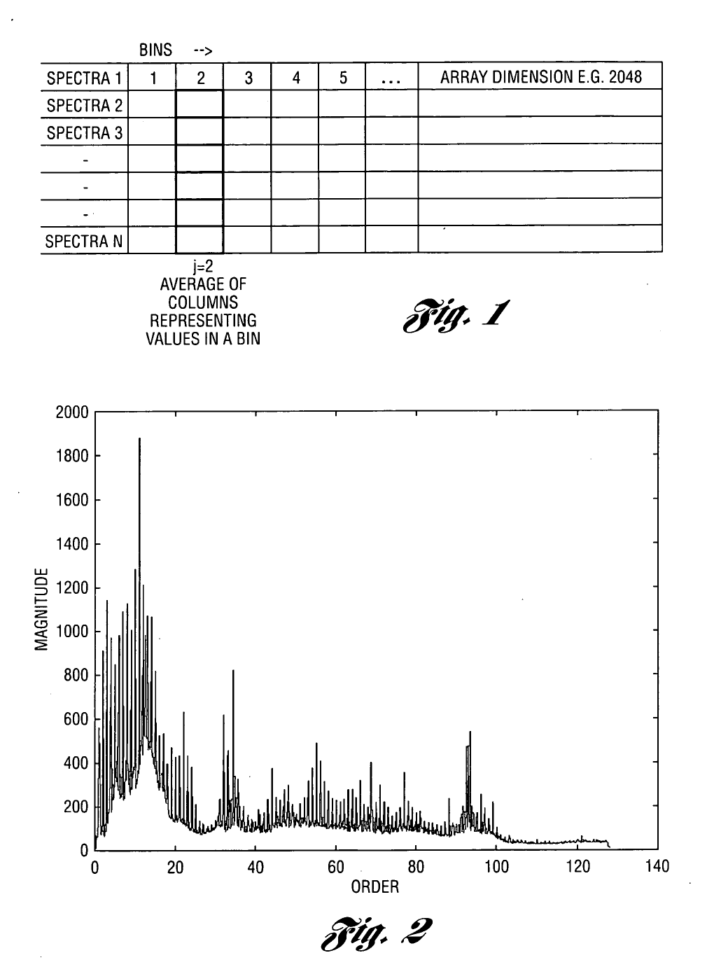

Step a refers to good part array Aᵢ and defect array Bᵢ given respectfully be equation 1 and 2:
(A₁, A₂, . . . Aₙ) 1;
(B₁, B₂, . . . Bₙ) 2.
The term “array” as used herein refers to a collection of numerical quantities that are arranged by some reference parameter. That is, a given position in this arrangement will correspond to the same value of the reference parameter. For example, when the array refers to a frequency spectrum, a given position in the array corresponds to a particular frequency. When the array refers to an rotational order spectrum, a given position in the array refers to a particular rotational order. Good part array Aᵢ provides information about a part without a defect and defect array Bᵢ provides information about a part with a known defect. Sometimes defect array Bᵢ will be referred to as a defect signature. Preferably, each member of these arrays will be average values taken from several parts. With reference to FIG. 1, the averaging of arrays from several parts (either all without a defect or all with a known defect) is illustrated. Spectra of N parts are measured to form N arrays whose values are stored in n bins. The number of each bin corresponds to a value for j which runs from 1 to n. The values for each j are then averaged over the N parts.

A number of different numerically quantifiable properties may be used in the method of the invention. The term “numerically quantifiable properties” as used herein refers to measurable characteristics of a part that can be reduced to a number. Obviously, there are a multitude of measured physical properties that may be used to characterize a part i.e., vibrational magnitude, temperature, weight, and the like. However, the quantifiable physical properties that are useful in practicing the invention must be able to differentiate between parts with defects-and parts without defects. A particularly useful property for this purpose is the vibrational frequency spectrum. The vibrational frequency spectrum is the vibrational magnitude at one or more positions on a part as a function of frequency. When such a frequency spectrum is used, good part array Aᵢ, defect array Bᵢ, and array Fᵢ are each ordered by n frequencies. These are the frequencies at which the vibrational magnitudes are measured. The n numerical values in good part array Aᵢ are magnitudes from the frequency spectrum of the first reference part without a defect at each of the n frequencies. The n numerical values in defect array Bᵢ are magnitudes from the frequency spectrum of the second reference part with a known defect at each of the n frequencies. Similarly, the n numerical values in array Fᵢ are magnitudes from the frequency spectrum of a test part that may have an unknown defect at each of the n frequencies. The frequency spectrum of the first reference part, the second reference part, and the test part are each determined by independently subjecting each of the first reference part, the second reference part, and the test part to energy that is sufficient to excite vibrational modes in each part, followed by measuring the magnitude of vibrations at one or more positions on each as a function of time to form a time domain spectra that is a plot of the magnitude of the vibrational energy as a function of time, and then creating a frequency domain spectra for each part by taking the Fourier transform of the time domain signal. The method of the invention is advantageously applied to parts that are components of a vehicle powertrain and then subjecting the part to energy that is sufficient to excite vibrational modes in a part. Typically, this is accomplished by operating the part in a manner as the part would be operated during operation of the powertrain.

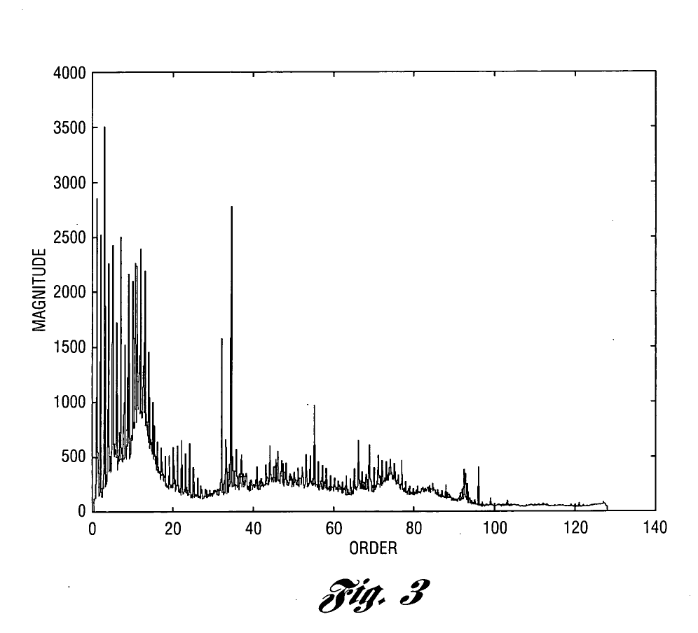

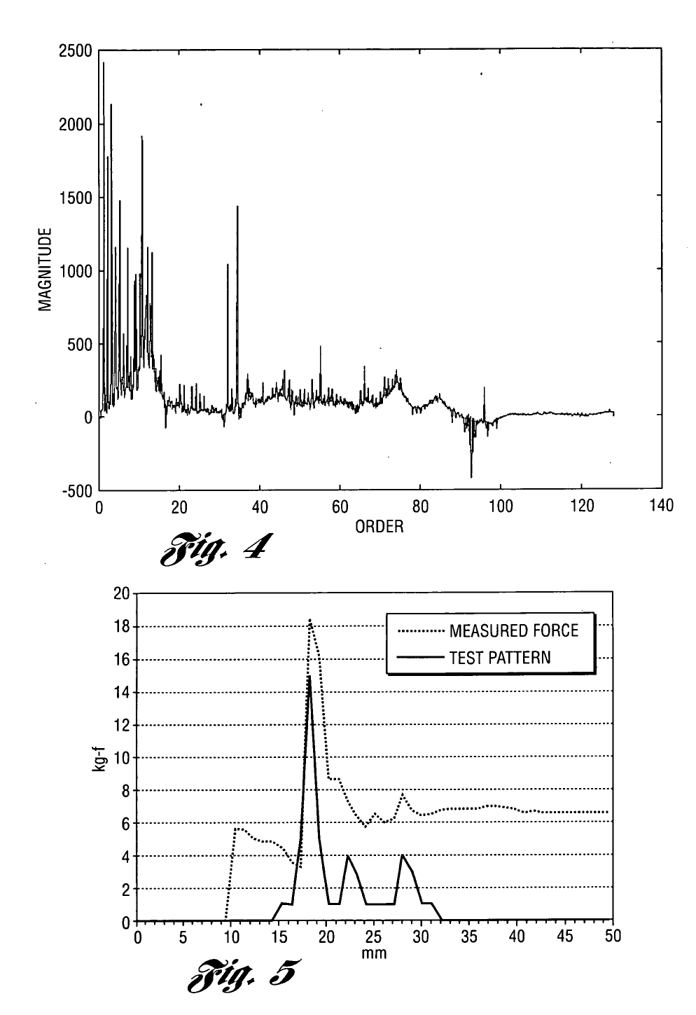

The analysis is somewhat simplified by calculating for each n frequencies a corresponding order. As used herein, order is determined by dividing a frequency in the frequency spectrum by a reference frequency. Typically, such a reference frequency is an input rotational frequency or output rotational frequency determined by the rotation of a shaft within the part. The frequency spectrum may then be reexpressed as a rotational order spectrum. A rotational order spectrum is a plot of the vibration magnitude as a function of order. When such a rotational order spectrum is used the good part array Aᵢ, defect array Bᵢ, and array Fᵢ are each ordered by the n rotational orders. Moreover, the n numerical values in good part array Aᵢ are magnitudes from the rotational order spectrum of the first reference part without a defect at each of the n orders; the n numerical values in defect array Bᵢ are magnitudes from the rotational order spectrum of the second reference part with the known defect at each of the n orders; and the n numerical values in array Fᵢ are magnitudes from the order spectrum of the test part that may have an unknown defect at each of the n orders. FIG. 2 provides the rotational order spectrum of a part without a defect and FIG. 3 provides the rotational order spectrum for a part with a known defect—pump pollution. In the case of transmission test a laser vibrometer was aimed on the case of the transmission near the planetary gear set. The signals were processed by a Reilhofer Spectrum Analyzer and delivered to a host computer for storage and analysis. The spectrum is 2048 elements in length, with an order bin width of ⅛ order. The bin magnitude data is represented by a 12-bit real number in each of the 2048 bins. FIG. 4 provides the corresponding difference spectrum calculated from FIGS. 2 and 3 which corresponds to the difference vector C calculated in step d.

In step f, the m largest magnitudes in vector are identified. Table 1 provide such an identification for the vector corresponding to FIG. 3. In table 1, the top (m=10) values of vector D are stored as (order, value) pairs.

TABLE 1
Top 10 magnitudes for vector D with the corresponding
order (in this case, the order is parameter pᵢ)

| Order | Value |
|---|---|
| 1.13 | 2431.78 |
| 1.19 | 2096.74 |
| 1.25 | 2031.85 |
| 2.13 | 1789.65 |
| 3.00 | 2149.42 |
| 3.06 | 2149.42 |
| 3.13 | 2149.42 |
| 10.56 | 1930.15 |
| 10.63 | 1907.42 |
| 10.69 | 1902.81 |

The method of the present embodiment is advantageously applied to a set of parts with known defect by iteratively repeating steps a through o for each member of such a set.

In another embodiment of the present invention, a method of determining the presence of a defect in which the method set forth above is applied iteratively for a number of defects is provided. The method of this embodiment comprises:
a) providing a first collection of reference parts wherein each part in the set has a known defect;
b) identifying a numerically quantifiable physical property that provides good part array Aᵢ of n values given in equation 1 that characterizes a part without a defect and provides a collection B^{j}ᵢ of arrays given by equation 17 that characterize each part in the collection of reference parts, each member of the second collection of arrays corresponds to one member of the collection of reference parts and has n dimensions:
   Aᵢε(A₁, A₂, . . . Aₙ) 1;
   B^{j}ᵢε(B^{j}₁, B^{j}₂, . . . B^{j}ₙ) 16;
   wherein,
n is an integer, and
array Aᵢ and arrays B^{j}ᵢ are ordered by the same independent parameter pᵢ that is associated with the values in array Aᵢ and arrays B^{j}ᵢ through the functional relationship Aᵢ=fₐ(pᵢ) and B^{j}ᵢ=f^{j}_{b}(pᵢ);
c) creating good part vector A of n dimensions given by equation 3 whose components are the n numerical values in good part array Aᵢ
   A=<A₁, A₂, . . . Aₙ> 3;
d) creating collection B^{j} of defect vectors of n dimensions as given in equation 17, the components of each defect vector in the third collection being the n numerical values of each array in the second collection of arrays;
   B^{j}=<B^{j}₁, B^{j}₂, . . . B^{j}ₙ> 17;

e) creating a set of difference vectors C^{j} each of n dimensions given by equation 18, the components of each difference vector C^{j} in the fourth collection being the difference between good part vector A and each defect vector B^{j}:
C^{j}=A−B^{j} 18;
f) identifying m components of vector C^{j} as provided by equation 19 having the largest magnitudes:
   C^{j}ᵢε(C^{j}′₁, C^{j}′₂, . . . C^{j}′ₘ) 19;
   wherein the m components are expressable as array C^{j}, the largest magnitudes are identified independently for each vector C^{j}, and each component of the C^{j}′ correspond to a value of the parameter pᵢ;
g) creating vector D^{j} of m dimensions as provided by equation 20 whose components are the n values in array C^{j}ᵢ:

$${D}^{j} = 〈 {C}_{1}^{j ′} , {C}_{2}^{j ′} , … {C}_{m}^{j ′} 〉 \\ = 〈 {D}_{1}^{j ′} , {D}_{2}^{j ′} , … {D}_{m}^{j ′} 〉 ; \qquad 20$$
h) normalizing vector D^{j} to form vector E^{j} as provided in equation 21:
   E^{j}=D^{j}/|D^{j}| 21;
i) determining array Fᵢ of n numerical values as provided by equation 22 using the numerically quantifiable physical property that characterize a test part that may have an unknown defect:
   Fᵢε(F₁, F₂, . . . Fₙ) 22;
j) creating vector F of n dimensions as provided by equation 23 whose components are the n values in array Fᵢ
   F=<F₁, F₂, . . . Fₙ> 23;
k) forming a vector G as provided by equation 24 which is the difference between vector A and vector F:
   G=A−F 24;
l) identifying m components of vector G as provided by equation 25 which correspond to the same values for pᵢ as the m components selected in step g:
   G′ᵢε(G′₁, G′₂, . . . G′ₘ) 25;
m) creating vector H as provided in equation 26 of dimension m having as components only the m components of step m:

$$H = 〈 {G}_{1}^{′} , {G}_{2}^{′} , … {G}_{m}^{′} 〉 \\ = 〈 {H}_{1} , {H}_{2} , … {H}_{m} 〉 ; \qquad 26$$
n) optionally normalizing vector H to create vector I as provided in equation 27:
   I=H/|H| 27; and
o) creating a set of dot products DPⁱ as provided in equation 28:
   DPⁱ=E^{j}·I 28;
   wherein each dot product DPⁱ provides a number related to the probability that the test part that may have an unknown defect has the known defect in the second reference part with the largest dot product corresponds to the most likely defect in the product with an unknown defect. As set forth above, the numerical physical property is a frequency spectrum which is the vibrational magnitude at one or more positions on the part as a function of frequency.

As set forth above, good part array Aᵢ, defect array Bᵢ, and array Fᵢ are each ordered by n frequencies. The n numerical values in good part array Aᵢ are magnitudes from the frequency spectrum of the first reference part without a defect at each of the n frequencies. The n numerical values in defect array Bᵢ are magnitudes from the frequency spectrum of the second reference part with a known defect at each of the n frequencies. Similarly, the n numerical values in array Fᵢ are magnitudes from the frequency spectrum of a test part that may have an unknown defect at each of the n frequencies. The determination of the frequency spectrum and the rotational order spectrum of the first reference part, the second reference part, and the test part is the same as set forth above.

In still another variation of the present invention, a method of characterizing defects in a part is provided. The method of this embodiment comprises:
a) identifying a numerically quantifiable physical property in a part which is expressible as a measured dependant variable Y^{d}ᵢ as a function of an independent variable xᵢ for a first reference part wherein the measured dependant variable is determined at discrete intervals of the independent variable given by equation 31:
   Xᵢ₊₁=Xᵢ+c 31;
   wherein c is a constant;
b) providing a test pattern for the numerically quantifiable physical property such that dependant variable Yⁿᵢ is expressed as a function of an independent variable Xᵢ wherein values of Yⁿᵢ are given at discrete intervals of the independent variable given by equation 32:
   X′ᵢ₊₁=X′ᵢ+c 32;
   wherein X′₀=X₀+d and d is adjustable offset; and
c) forming the dot product sum DP given by equation 33:
   DP=ΣY^{d}ᵢY^{u}ᵢ 33;
   wherein d is adjusted and successive summations preformed until the maximum value for P. In one variation of the this embodiment the first reference part will be a part with a known defect and the test pattern will be determined by measuring dependant variable Yⁿᵢ as a function of an independent variable Xᵢ for a part that has an unknown defect. DP will be recognized as the dot product between vector Y^{d} and Y^{u}. This maximum value provides highest probability of the existence of the pattern in the data stream that is being searched. This analysis may be repeated for parts with different know defects. The know defect part that gives the overall highest value for P is the contains the defect most likely in the part with an unknown defect. Xᵢ and X′ᵢ are preferably restricted to adjacent values in the embodiment. Preferably, Xᵢ and X′ᵢ are restricted to adjacent values where Y^{d}ᵢ and Y^{u}ᵢ show maximal variation. Moreover, Y^{d}ᵢ may be measured at more values of Xᵢ then for values of X′ᵢ used in measuring Y^{u}ᵢ. In this instance, the missing X′ᵢ are formally given a value of zero. This embodiment allows extension of the method of the present invention to any numerically quantifiable property that is expressable as a signal exhibits regularly spaced data points expressable on an x-axis that have a repeatable, numerically quantifiable pattern that exists in the data. If this is true, the method of the invention can be used to test for the existence of a pre-defined shapes. Signals amenable to this analysis preferably fulfill the following criteria: (1) the signal can be represented as an array of numbers; (2) The signal produces regularly shaped patterns that may be shifted along the x-axis or superimposed with other signals, or have similar scaled shapes in the y-axis magnitudes; (3) the signals exhibit common spacing on the x-axis. With reference to FIG. 5, time domain plots that have been analyzed using the method of the invention to identify a part with a missing ring in a piston are provided. For this-example, a Kawasaki FS-45N robot was equipped with a force sensor. Tooling on the distal end of the force transducer pushes the piston into an engine bore. During this motion the forces of assembly are recorded on a force transducer. These forces are used to construct a vector of peak forces in ea mm. The dimension of the signal Y^{d}ᵢ (and Y^{u}ᵢ) can be quite large if a large number of data points are taken. For example, if one is measuring force vs. distance of a piston undergoing insertion into an engine bore, there are known geometric features that can be expected to produce an output force signal such as the rings on the piston. These rings are at known and constant distances from each other on the piston and can be sensed through the use of the dot product method. Determine the nature of the expected signal to search for in the data stream. In this case we want to search for a pattern like this in the data Y^{d}ᵢ: A=(1,5,50,5,1,1,1,10,15,10,1,1,10,15, 10,1). The dimension of A in this example is 16. This represents one large peak followed by two other smaller peaks which represents the forces from assembly the are incurred as the piston is stuffed into the engine bore with an X-Axis of mm. Perform a dot product operation of this test vector A on every point possible of the in the data, S, and the capture the location of the best match using a dot product result as the test criteria. To do this matching, take subsequent snippets of the input data of the same length as A and construct a comparison vectors from S that are successive snippets of length m, and store the results in. P which has a reduced dimension length from n to n-m. By locating the relevant feature shapes in input data streams, by detecting at which n is the location of the maximum in P. Storing this index n allows offsets in the data stream Y^{u}ᵢ to be directly tested to be within magnitude limits. Violations of the magnitude limits at predefined offset values can be used to test for the existence of some feature such as a missing piston ring.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method of characterizing defects in a part, the method comprising:
a) identifying a numerically quantifiable physical property that provides good part array Aᵢ of n numerical values given by equation 1 that characterize a first reference part without a defect and defect array Bᵢ of n values as provided by equation 2 that characterize a second reference part with a known defect:
Aᵢε(A₁, A₂, . . . Aₙ) 1;
Bᵢε(B₁, B₂, . . . Bₙ) 2;
wherein,
n is an integer, and
array Aᵢ and array Bᵢ are ordered by an independent parameter pᵢ that is associated with the values in array Aᵢ and array Bᵢ through the functional relationship Aᵢ=fₐ(pᵢ) and Bᵢ=f_{b}(pᵢ);
b) creating good part vector A of n dimensions as provided by equation 3 whose components are the n numerical values in good part array Aᵢ:
A=<A₁, A₂, . . . Aₙ> 3;
c) creating defect vector B of n dimensions as provided by equation 4 whose components are the n values in defect array Bᵢ:
B=<B₁, B₂, . . . Bₙ> 4;
d) identifying vector R by selecting a vector from the group consisting of vector B, vector C, vector D, and vector E;
wherein,
vector C is created by taking the difference between good part vector A and defect vector B as provided in equation 5:
C=A−B 5; and
vector D is formed by:
1) creating difference vector C of n dimensions as provided by equation 5 which is the difference between good part vector A and defect vector B:
C=A−B 5;
2) identifying m components of vector C as provided by equation 6 having the largest magnitudes:
C′ᵢε(C′₁, C′₂, . . . C′ₘ) 6;
3) creating vector D of m dimensions as provided by equation 7 whose components are the n values in array C′ᵢ
$$D = 〈 {C}_{1}^{′} , {C}_{2}^{′} , … {C}_{m}^{′} 〉 \\ = 〈 {D}_{1} , {D}_{2} , … {D}_{m} 〉 ; \qquad 7$$
and
vector E is formed by:
1) creating difference vector C of n dimensions as provided by equation 5 which is the difference between good part vector A and defect vector B:
C=A−B 5;
2) identifying m components of vector C as provided by equation 6 having the largest magnitudes:
C′ᵢε(C′₁, C′₂, . . . C′ₘ) 6;
3) creating vector D of m dimensions as provided by equation 7 whose components are the n values in array
$$D = 〈 {C}_{1}^{′} , {C}_{2}^{′} , … {C}_{m}^{′} 〉 \\ = 〈 {D}_{1} , {D}_{2} , … {D}_{m} 〉 ; \qquad 7$$
7; and
5) normalizing vector D to form vector E as provided in equation 9:
E=D/|D| 8;
e) determining array Fᵢ of n numerical values as provided by equation 9 that characterize a test part that may have an unknown defect using the numerically quantifiable physical property:
Fᵢε(F₁, F₂, . . . Fₙ) 9;
f) creating vector F of n dimensions as provided by equation 10 whose components are the n values in array Fᵢ:
F<F₁, F₂, . . . Fₙ> 10;
9) identifying vector S by selecting a vector selected from the group consisting of vector F, vector G, vector H, and vector I,
wherein,
vector G is formed by taking the difference between vector A and vector F as provided in equation 11;
G=A−F 11; and
vector H is formed by:
1) creating vector G as provided by equation 11 which is the difference between vector A and vector F:
G=A−F 11;
2) identifying m components of vector G as provided by equation 12 which correspond to the same values for pᵢ as the m components selected in step d for vector F:
G′ᵢε(G′₁, G′₂, . . . G′ₘ) 12;
3) creating vector H as provided in equation 13 of dimension m having as components only the m components of step 2:
$$\begin{matrix}H = 〈 {G}_{1}^{′} , {G}_{2}^{′} , … {G}_{m}^{′} 〉 \\ = 〈 {H}_{1} , {H}_{2} , … {H}_{m} 〉 13 ;\end{matrix}$$
4) normalizing vector H to create vector I as provided in equation 14:
I=H/|H| 14; and
vector I is formed by:
1) creating vector G as provided by equation 11 which is the difference between-vector A and vector F:
G=A−F 11;
2) identifying m components of vector G as provided by equation 12 which correspond to the same values for pᵢ as the m components selected in step d for vector F:
G′ᵢε(G′₁, G′₂, . . . G′ₘ) 12;
3) creating vector H as provided in equation 13 of dimension m having as components only the m components of step 2:
$$\begin{matrix}H = 〈 {G}_{1}^{′} , {G}_{2}^{′} , … {G}_{m}^{′} 〉 \\ = 〈 {H}_{1} , {H}_{2} , … {H}_{m} 〉 13 ;\end{matrix}$$
4) normalizing vector H to create vector I as provided in equation 14:
I=H/|H| 14; and
h) forming dot product DP as provided in equation 15:
DP=R·S 15;
wherein the dot product provides a number related to the probability that the test part that may have an unknown defect has the known defect in the second reference part with the proviso that when
vector B is selected in step d vector F is selected in step g,
vector C is selected in step d vector G is selected in step g,
vector D is selected in step d vector H is selected in step g, and
vector E is selected in step d vector I is selected in step g.

2. The method of claim 1 wherein m is less than n.

3. The method of claim 1 wherein the dot product P is provided by DP=E·I.

4. The method of claim 1 wherein each of the normalization steps is performed by dividing a vector component of a vector to be normalized by the magnitude of the vector, the magnitude given by the square root of the sums of the squares of the vector components.

5. The method of claim 1 wherein the numerical physical property is a frequency spectrum which is the vibrational magnitude at one or more positions on the part as a function of frequency.

6. The method of claim 5 wherein
good part array Aᵢ, defect array Bᵢ, and array Fᵢ are each ordered by n frequencies;
the n numerical values in good part array Aᵢ are magnitudes from the frequency spectrum of the first reference part without a defect at each of the n frequencies;
the n numerical values in defect array Bᵢ are magnitudes from the frequency spectrum of the second reference part with a known defect at each of the n frequencies; and
the n numerical values in array Fᵢ are magnitudes from the frequency spectrum of a test part that may have an unknown defect at each of the n frequencies.

7. The method of claim 6 wherein the frequency spectrum of the first reference part, the second reference part, and the test part are determined by:
independently subjecting each of the first reference part, the second reference part, and the test part to energy that is sufficient to excite vibrational modes in each part;
independently measuring the magnitude of vibrations at one or more positions on each as a function of time to form a time domain spectra that is a plot of the magnitude of the vibrational energy as a function of time; and
independently creating a frequency domain spectra for each part by taking the Fourier transform of the time domain spectra.

8. The method of claim 7 wherein the part is a component of a vehicle powertrain and the subjecting a part to energy that is sufficient to excite vibrational modes in a part comprises:
operating the part in a manner as the part would be operated during operation of the powertrain.

9. The method of claim 7 further comprising:
calculating for each n frequencies a corresponding order;
reexpressing the frequency spectrum as a rotational order spectrum which is a plot of the vibration magnitude as a function of rotational order; wherein
the good part array Aᵢ, defect array Bᵢ, and array Fᵢ are each ordered by the n rotational orders;
the n numerical values in good part array Aᵢ are magnitudes from the rotational order spectrum of the first reference part without a defect at each of the n orders;
the n numerical values in defect array Bᵢ are magnitudes from the rotational order spectrum of the second reference part with the known defect at each of the n orders; and
the n numerical values in array Fᵢ are magnitudes from the order spectrum of the test part that may have an unknown defect at each of the n orders.

10. The method of claim 9 wherein the order is determined by dividing a frequency in the frequency spectrum by a reference frequency.

11. The method of claim 9 wherein the reference frequency is an input rotational frequency or output rotational frequency.

12. The method of claim 9 wherein the rotational frequency is determined of the rotation of a shaft within the part.

13. The method of claim 1 wherein steps a through o for each member of a set parts each with a known defects wherein the defect vector B is created for each member of the set.

14. A method of characterizing defects in a part, the method comprising:
a) providing a first collection of reference parts wherein each part in the set has a known defect;
b) identifying a numerically quantifiable physical property that provides good part array Aᵢ of n values given in equation 1 that characterizes a part without a defect and provides a collection B^{j}ᵢ of arrays given by equation 17 that characterize each part in the collection of reference parts, each member of the second collection of arrays corresponds to one member of the collection of reference parts and has n dimensions:
Aᵢε(A₁, A₂, . . . Aₙ) 1;
B^{j}ᵢε(B^{j}₁, B^{j}₂, . . . B^{j}ₙ) 16;
wherein,
n is an integer, and
array Aᵢ and array B^{j}ᵢ are ordered by the same independent parameter pᵢ that is associated with the values in array Aᵢ and array B^{j}ᵢ through the functional relationship Aᵢ=fₐ(pᵢ) and B^{j}ᵢ=f^{j}_{b}(pᵢ);
c) creating good part vector A of n dimensions given by equation 3 whose components are the n numerical values in good part array Aᵢ
A=<A₁, A₂, . . . Aₙ> 3;
d) creating collection B^{j} of defect vectors of n dimensions as given in equation 17, the components of each defect vector in the third collection being the n numerical values of each array in the second collection of arrays;
B^{j}=<B^{j}₁, B^{j}₂, . . . . B^{j}ₙ> 17;
e) creating a set of difference vectors C^{j} each of n dimensions given by equation 18, the components of each difference vector C^{j} in the fourth collection being the difference between good part vector A and each defect vector B^{j}:
C^{j}=A−B^{j} 18;
f) identifying m components of vector C^{j} as provided by equation 19 having the largest magnitudes:
C^{j′}ᵢε(C^{j}′₁, C^{j}′₂, . . . C^{j}′ₘ) 19;
wherein the m components are expressable as array C^{j}′ᵢ, the largest magnitudes are identified independently for each vector C^{j}, and each component of the C^{j}′ᵢ correspond to a value of the parameter pᵢ;
g) creating vector D^{j} of m dimensions as provided by equation 20 whose components are the n values in array C^{j′}ᵢ
$$\begin{matrix}{D}^{j} = 〈 {C}_{1}^{j ′} , {C}_{2}^{j ′} , … {C}_{m}^{j ′} 〉 \\ = 〈 {D}_{1}^{j ′} , {D}_{2}^{j ′} , … {D}_{m}^{j ′} 〉 20 ;\end{matrix}$$
h) normalizing vector D^{j} to form vector E^{j} as provided in equation 21:
E^{j}=D^{j}/|D^{j}| 21;
i) determining array Fᵢ of n numerical values as provided by equation 22 using the numerically quantifiable physical property that characterize a test part that may have an unknown defect
Fᵢε(F₁, F₂, . . . Fₙ) 22;
j) creating vector F of n dimensions as provided by equation 23 whose components are the n values in array Fᵢ
F=<F₁, F₂, . . . Fₙ> 23;
k) forming a vector G as provided by equation 24 which is the difference between vector A and vector F:
G=A−F 24;
l) identifying m components of vector G as provided by equation 25 which correspond to the same values for pᵢ as the m components selected in step g:
G′ᵢε(G′₁, G′₂, . . . G′ₘ) 25;
m) creating vector H as provided in equation 26 of dimension m having as components only the m components of step m:
$$\begin{matrix}H = 〈 {G}_{1}^{′} , {G}_{2}^{′} , … {G}_{m}^{′} 〉 \\ = 〈 {H}_{1} , {H}_{2} , … {H}_{m} 〉 26 ;\end{matrix}$$
n) optionally normalizing vector H to create vector I as provided in equation 27:
I=H/|H| 27; and
o) creating a set of dot products DPⁱ as provided in equation 28:
DPⁱ=E^{j}·I 28;
wherein each dot product DPⁱ provides a number related to the probability that the test part that may have an unknown defect has the known defect in the second reference part with the largest dot product corresponds to the most likely defect in the product with an unknown defect.

15. The method of claim 14 wherein the numerically quantifiable physical property is a frequency spectrum which is the vibrational magnitude at one or more positions on the part as a function of frequency.

16. The method of claim 15 wherein
good part array Aᵢ, defect array Bᵢ, and array Fᵢ are each ordered by n frequencies;
the n numerical values in good part array Aᵢ are magnitudes from the frequency spectrum of the first reference part without a defect at each of the n frequencies;
the n numerical values in defect array Bᵢ are magnitudes from the frequency spectrum of the second reference part with a known defect at each of the n frequencies; and
the n numerical values in array Fᵢ are magnitudes from the frequency spectrum of a test part that may have-an unknown defect at each of the n frequencies.

17. The method of claim 16 wherein the frequency spectrum of the first reference part, the second reference part, and the test part are determined by:
independently subjecting each of the first reference part, the second reference part, and the test part to energy that is sufficient to excite vibrational modes in each part;
independently measuring the magnitude of vibrations at one or more positions on each as a function of time to form a time domain spectra that is a plot of the magnitude of the vibrational energy as a function of time; and
independently creating a frequency domain spectra for each part by taking the Fourier transform of the time domain spectra.

18. The method of claim 17 wherein first reference part, the second reference part, and the test part are each a component of a vehicle powertrain and the subjecting a part to energy that is sufficient to excite vibrational modes in a part comprises:
operating the part in a manner as the part would be operated during operation of the powertrain.

19. The method of claim 18 further comprising:
calculating for each n frequencies a corresponding order;
reexpressing the frequency spectrum as a rotational order spectrum which is a plot of the vibration magnitude as a function of rotational order; wherein
the good part array Aᵢ, defect array Bᵢ, and array Fᵢ are each ordered by the n rotational orders;
the n numerical values in good part array Aᵢ are magnitudes from the rotational order spectrum of the first reference part without a defect at each of the n orders;
the n numerical values in defect array Bᵢ are magnitudes from the rotational order spectrum of the second reference part with the known defect at each of the n orders; and
the n numerical values in array Fᵢ are magnitudes from the order spectrum of the test part that may have an unknown defect at each of the n orders.

20. The method of claim 19 wherein the order is determined by dividing a frequency in the frequency spectrum by a reference frequency.

21. The method of claim 19 wherein the reference frequency is an input rotational frequency or output rotational frequency.

22. The method of claim 21 wherein the rotational frequency is determined of the rotation of a shaft within the part.

23. A method of characterizing defects in a part, the method comprising:
a) identifying a numerically quantifiable physical property that provides good part array Aᵢ of n numerical values given by equation 1 that characterize a first reference part without a defect and defect array Bᵢ of n values as provided by equation 2 that characterize a second reference part with a known defect:
Aᵢε(A₁, A₂, . . . Aₙ) 1;
Bᵢε(B₁, B₂, . . . Bₙ) 2;
wherein,
n is an integer, and
array Aᵢ and array Bᵢ are ordered by an independent parameter pᵢ that is associated with the values in array Aᵢ and array Bᵢ through the functional relationship Aᵢ=fₐ(pᵢ) and Bᵢ=f_{b}(pᵢ);
b) creating good part vector A of n dimensions as provided by equation 3 whose components are the n numerical values in good part array Aᵢ:
A=<A₁, A₂, . . . Aₙ> 3;
c) creating defect vector B of n dimensions as provided by equation 4 whose components are the n values in defect array Bᵢ:
B=<B₁, B₂, . . . Bₙ> 4;
d) forming vector E by the method comprising;
1) creating difference vector C of n dimensions as provided by equation 5 which is the difference between good part vector A and defect vector B:
C=A−B 5;
2) identifying m components of vector C as provided by equation 6 having the largest magnitudes:
C′ᵢε(C′₁, C′₂, . . . C′ₘ) 6;
3) creating vector D of m dimensions as provided by equation 7 whose components are the n values in array C′ᵢ
$$\begin{matrix}D = 〈 {C}_{1}^{′} , {C}_{2}^{′} , … {C}_{m}^{′} 〉 \\ = 〈 {D}_{1} , {D}_{2} , … {D}_{m} 〉 7 ;\end{matrix}$$
and
5) normalizing vector D to form vector E as provided in equation 9:
E=D/|D| 8;
e) determining array Fᵢ of n numerical values as provided by equation 9 that characterize a test part that may have an unknown defect using the numerically quantifiable physical property:
Fᵢε(F₁, F₂, . . . Fₙ) 9;
f) creating vector F of n dimensions as provided by equation 10 whose components are the n values in array Fᵢ:
F=<F₁, F₂, . . . Fₙ> 10;
g) forming vector I by the method comprising:
1) creating vector G as provided by equation 11 which is the difference between vector A and vector F:
G=A−F 11;
2) identifying m components of vector G as provided by equation 12 which correspond to the same values for pᵢ as the m components selected in step d for vector F:
G′ᵢε(G′₁, G′₂, . . . G′ₘ) 12;
3) creating vector H as provided in equation 13 of dimension m having as components only the m components of step 2:
$$\begin{matrix}H = 〈 {G}_{1}^{′} , {G}_{2}^{′} , … {G}_{m}^{′} 〉 \\ = 〈 {H}_{1} , {H}_{2} , … {H}_{m} 〉 13 ;\end{matrix}$$
4) normalizing vector H to create vector I as provided in equation 14:
I=H/|H| 14; and
h) forming dot product DP as provided in equation 15′:
DP=E·I 15′;
wherein the dot product provides a number related to the probability that the test part that may have an unknown defect has the known defect in the second reference part.

24. A method of characterizing defects in a part, the method comprising:
a) identifying a numerically quantifiable physical property that provides good part array Aᵢ of n numerical values given by equation 1 that characterize a first reference part without a defect and defect array Bᵢ of n values as provided by equation 2 that characterize a second reference part with a known defect:
Aᵢε(A₁, A₂, . . . Aₙ) 1;
Bᵢε(B₁, B₂, . . . Bₙ) 2;
wherein,
n is an integer, and
array Aᵢ and array Bᵢ are ordered by an independent parameter pᵢ that is associated with the values in array Aᵢ and array Bᵢ through the functional relationship Aᵢ=fₐ(pᵢ) and Bᵢ=f_{b}(pᵢ);
b) creating good part vector A of n dimensions as provided by equation 3 whose components are the n numerical values in good part array Aᵢ:
A=<A₁, A₂, . . . Aₙ> 3;
c) creating defect vector B of n dimensions as provided by equation 4 whose components are the n values in defect array Bᵢ:
B=<B₁, B₂, . . . Bₙ> 4;
e) determining array Fᵢ of n numerical values as provided by equation 9 that characterize a test part that may have an unknown defect using the numerically quantifiable physical property:
Fᵢε(F₁, F₂, . . . Fₙ) 9;
f) creating vector F of n dimensions as provided by equation 10 whose components are the n values in array Fᵢ:
F=<F₁, F₂, . . . Fₙ> 10; and
h) forming dot product DP as provided in equation 15:
DP=B·F 15;
wherein the dot product provides a number related to the probability that the test part that may have an unknown defect has the known defect in the second reference part.

25. A method of characterizing defects in a part, the method comprising:
a) identifying a numerically quantifiable physical property in a part which is expressible as a measured dependant variable Y^{d}ᵢ as a function of an independent variable Xᵢ for a first reference part that has a known defect and wherein the measured dependant variable is determined at discrete intervals of the independent variable given by equation 31:
Xᵢ₊₁=Xᵢ+c 31;
wherein c is a constant;
b) providing a test pattern for the numerically quantifiable physical property such that dependant variable Yⁿᵢ is expressed as a function of an independent variable Xᵢ wherein values of Yⁿᵢ are given at discrete intervals of the independent variable given by equation 32:
X′ᵢ₊₁=X′ᵢ+c 32;
wherein X′₀=X₀+d and d is adjustable offset; and
c) forming the dot product sum DP given by equation 27:
DP=ΣY^{d}ᵢY^{u}ᵢ 33;
wherein d is adjusted to provide the maximum value for P.

26. The method of claim 24 wherein the first reference part is a part with a known defect and the test pattern is determined by measuring the numerically quantifiable physical property to calculate dependant variable Yⁿᵢ as a function of an independent variable Xⁱ for a part that has an unknown defect.

27. The method of claim 24 wherein Xᵢ and ′ᵢ are restricted to adjacent values where Y^{d}ᵢ and Y^{u}ᵢ show variation.

28. The method of claim 24 wherein Xᵢ and X′ᵢ are time and Y^{d}ᵢ and Y^{u}ᵢ are the distance traveled by a cylinder in an internal combustion engine.
